(19) United States
(12) Patent Application Publication
(10) Pub. No.: US 2015/0144694 A1
(43) Pub. Date: May 28, 2015

(54) LOOP ANTENNA AND METHOD FOR SWITCHING THE SAME

(71) Applicant: ELECTRONICS AND TELECOMMUNICATIONS RESEARCH INSTITUTE, Daejeon (KR)

(72) Inventors: Won Kyu CHOI, Daejeon (KR); Hoe-Sung YANG, Daejeon (KR); Chan-Won PARK, Daejeon (KR); Cheol Sig PYO, Daejeon (KR); Hae-Won SON, Jeonju (KR)

(73) Assignee: ELECTRONICS AND TELECOMMUNICATIONS RESEARCH INSTITUTE, Daejeon (KR)

(21) Appl. No.: 14/251,238

(22) Filed: Apr. 11, 2014

(30) Foreign Application Priority Data
Nov. 26, 2013 (KR) 10-2013-0144920

(51) Int. Cl. G06K 7/10

(52) U.S. Cl. CPC G06K 7/10336
USPC 235/439

(57) ABSTRACT

The loop antenna includes a loop coil connected to an RF signal source of a reader through a feed cable, and a switch that is turned on and off depending on a DC voltage that is proportional to the magnitude of an RF signal supplied from the RF signal source of the reader and opens the loop coil when turned off and closes the loop coil when turned on.

### CROSS-REFERENCE TO RELATED APPLICATION

This application claims priority to and the benefit of Korean Patent Application No. 10-2013-0144920 filed in the Korean Intellectual Property Office on Nov. 26, 2013, the entire contents of which are incorporated herein by reference.

### BACKGROUND OF THE INVENTION

(a) Field of the Invention

The present invention relates to a loop antenna and a method for switching the same, and more particularly, to a method for switching a loop antenna which is mounted and used on a reader of an RFID (Radio Frequency Identification) system using inductive coupling.

(b) Description of the Related Art

An RFID (Radio Frequency Identification) system consists of a tag (or transponder) and a reader (or interrogator). When the tag is placed in a read zone, the reader sends an interrogation to the tag, and the tag responds to the interrogation from the reader.

In a passive RFID system using inductive coupling, reader and tag antennas are in the shape of loop antennas and are mutually coupled by a time-varying magnetic field. The reader antenna generates a strong magnetic field around itself, and transmits signals and power to the tag antenna by inductive coupling.

In the passive RFID system using inductive coupling, the tag has no power source of its own, such as a battery, and receives an AC magnetic field sent from the reader antenna and produces required power. Accordingly, in order to increase the communication distance between the reader and the tag, it is necessary to maximize the intensity of the magnetic field sent from the reader antenna. For this reason, a loop antenna mounted on the reader is designed to resonate with the frequency of an RF output signal from the reader.

Depending on RFID applications, two or more loop antennas can be placed close to each other for operation. For example, in case of a smart shelf using RFID, it is more efficient to manage the entire shelf by placing a plurality of small loop antennas on the shelf close to each other, without overlapping, and operating them alternately, rather than placing one big loop antenna across the entire shelf. In this case, a reader has a plurality of antenna ports so as to mount multiple loop antennas simultaneously thereon, and the loop antennas alternately receive RF signals by using RF switching technology. In another example, in case of a casino table using RFID technology, loop antennas are placed in a plurality of betting areas neighboring each other, and a tag is embedded in each casino chip, so that casino chips that a player bets can be distinguished and identified by betting areas.

The loop antennas placed close to each other might interfere with each other and disturb the normal operation of the RFID system. As mentioned above, each of the loop antennas is designed to resonate with the frequency of RF output signals from the reader to ensure maximum power transfer to the tag. However, placing two loop antennas with the same resonant frequency close to each other may cause detuning of the resonant frequency when the loop antennas are coupled together, which significantly decreases the communication distance between the reader and the tag. Also, the casino table, which requires tags to be distinguished and identified by betting areas, may have an error of misidentifying the tags of neighboring betting areas with each other due to coupling between the loop antennas.

### SUMMARY OF THE INVENTION

The present invention has been made in an effort to provide a loop antenna which is capable of reducing interference between loop antennas, and a method for switching the same.

An exemplary embodiment of the present invention provides a loop antenna. The loop antenna includes a loop coil and a switch. The loop coil is connected to an RF signal source of a reader through a feed cable. The switch is turned on and off depending on a DC voltage that is proportional to the magnitude of an RF signal supplied from the RF signal source of the reader, and opens the loop coil when turned off and closes the loop coil when turned on.

The loop antenna may further include a signal extractor that extracts part of the RF signal, and a rectifier that rectifies the extracted RF signal and converts the rectified RF signal into the DC voltage.

The signal extractor may include an inductor connected between a power line of the feed cable and the rectifier.

The switch may include a relay switch.

The loop antenna may further include an impedance matching unit that matches the impedance between the feed cable and the loop antenna.

Another exemplary embodiment of the present invention provides a method for switching a loop antenna. The method for switching a loop antenna includes: generating a DC voltage that is proportional to the magnitude of an RF signal output from an RF signal source of a reader; and closing or opening a loop coil constituting the loop antenna depending on the DC voltage.

The loop antenna may include a switch connected midway through the loop coil, and the closing or opening may include: if the DC voltage is higher than a driving voltage of the switch, turning the switch on to close the loop coil; and if the DC voltage is lower than the driving voltage of the switch, turning the switch off to open the loop coil.

The switch may include a relay switch.

The generating may include: extracting part of the RF signal; and rectifying the extracted RF signal and converting the rectified RF signal into the DC voltage.

### BRIEF DESCRIPTION OF THE DRAWINGS

FIG. 1 is a view showing an example of two loop antennas placed close to each other.

FIG. 2 is a view showing a loop antenna according to an exemplary embodiment of the present invention.

FIG. 3 is a flowchart showing a method of operating a loop antenna according to an exemplary embodiment of the present invention.

FIG. 4 is a view showing a detailed configuration of the loop coil switching unit of FIG. 2.

FIG. 5 is a view showing another example of a loop antenna according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

A loop antenna and a method for switching the same according to an exemplary embodiment of the present invention will now be described in detail with reference to the drawings.

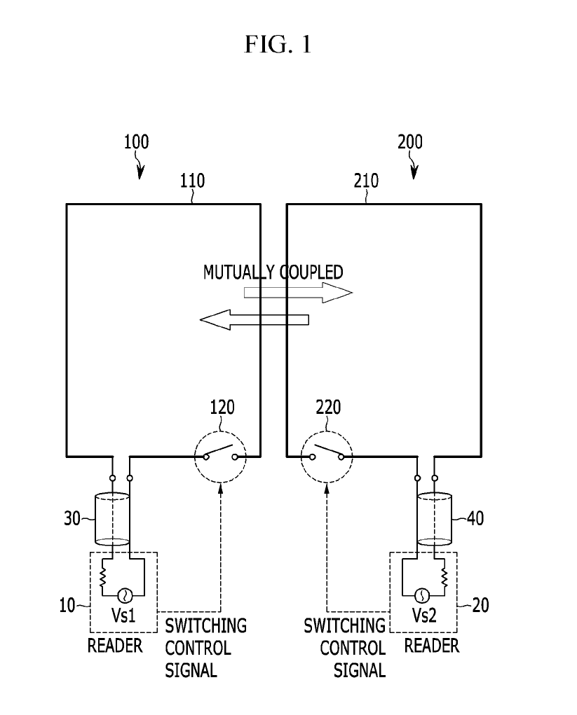

FIG. 1 is a view showing an example of two loop antennas placed close to each other.

Referring to FIG. 1, loop antennas 100 and 200 consist of coils 110 and 210, respectively.

Input terminals are formed at the ends of the coil (hereinafter referred to as a “loop coil”) 110 or 210 constituting each loop antenna 100 or 200. The input terminals are connected to an RF signal source Vs1 or Vs2 of a reader 10 or 20 through a feed cable 30 or 40.

As shown in FIG. 1, if the two loop antennas 100 and 200 are placed close to each other, detuning occurs due to coupling between the two loop antennas 100 and 200.

With the two loop antennas 100 and 200 placed close to each other, in order for the RFID system including readers and tags to normally operate, the loop coil 210 should be in an open state when an RF signal is supplied to the loop coil 110. Likewise, the loop coil 100 should be in an open state when an RF signal is supplied to the loop coil 210. To this end, the loop antennas 100 and 200 include coil switches 120 and 220 for closing or opening the loop coils 110 and 210.

The coil switch 120 is provided in the wire constituting the loop coil 110, and the coil switch 220 is provided in the wire constituting the loop coil 210.

The coil switch 220 is opened when an RF signal is supplied to the loop coil 110 (VS1=1, VS2=0), and the coil switch 120 is opened when an RF signal is supplied to the loop coil 210 (VS1=0, VS2=1). Thus, interference between the two loop antennas 100 and 200 can be suppressed.

In order to suppress the interference between the two loop antennas 100 and 200 in this method, it is necessary for the readers 10 and 20 to supply a switching control signal, as well as an RF signal, to the loop antennas 100 and 200 to drive the coil switches 120 and 220. However, commonly used readers do not have the function of supplying a switching control signal, so it is not easy to implement this method.

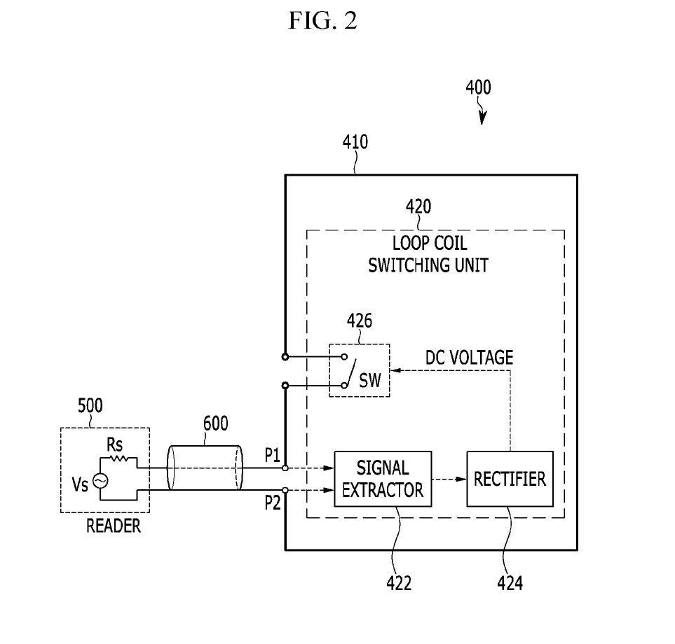

FIG. 2 is a view showing a loop antenna according to an exemplary embodiment of the present invention.

Referring to FIG. 2, the loop antenna 400 includes a loop coil 410 and a loop coil switching unit 420.

The loop coil 410 is wound at least once in a circular or rectangular shape, and input terminals of the loop coil 410 are connected to an RF signal source Vs of a reader 500 through a feed cable 600. The input terminal P1 is connected to a signal wire of the feed cable 600, and the input terminal P2 is connected to a grounding wire of the feed cable 600.

The loop coil switching unit 420 includes a signal extractor 422, a rectifier 424, and a switch part 426. The signal extractor 422 extracts part of an RF signal which goes into the loop coil 410. The rectifier 424 rectifies the extracted RF signal and converts it into a DC voltage. The switching unit 426 includes a switch SW, and two switch terminals of the switch SW are connected in the loop coil 410. The switch SW is turned on and off depending on the voltage output from the rectifier 424 and closes or opens the loop coil 410.

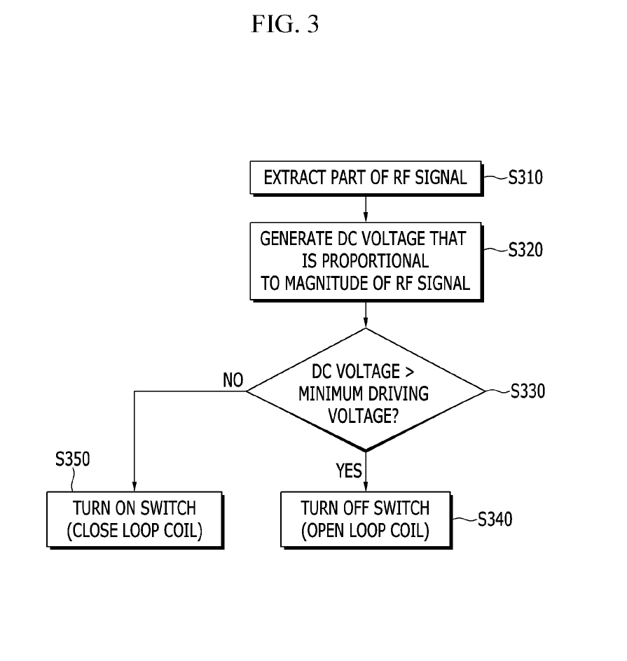

FIG. 3 is a flowchart showing a method of operating a loop antenna according to an exemplary embodiment of the present invention.

Referring to FIG. 3, when an RF signal is applied from the reader 500 to the input terminals P1 and P2 of the loop antenna 400, the signal extractor 422 extracts part of the RF signal and sends it to the rectifier 424 (S310), and the rectifier 424 generates a DC voltage that is proportional to the magnitude of the received RF signal and sends it to the switching unit 426 (S320). If the DC voltage generated by the rectifier 424 is higher than a minimum driving voltage of the switch SW (S330), the switch SW is turned on to close the loop coil 410 (S340). On the other hand, if the DC voltage generated by the rectifier 424 is lower than the minimum driving voltage of the switch SW (S330), the switch SW is turned off to place the loop coil 410 in the open state (S350).

As such, the loop coil switching unit 420 is able to close or open the loop coil 410 by using an RF signal, without receiving a switching control signal for operating the switch from the reader 500.

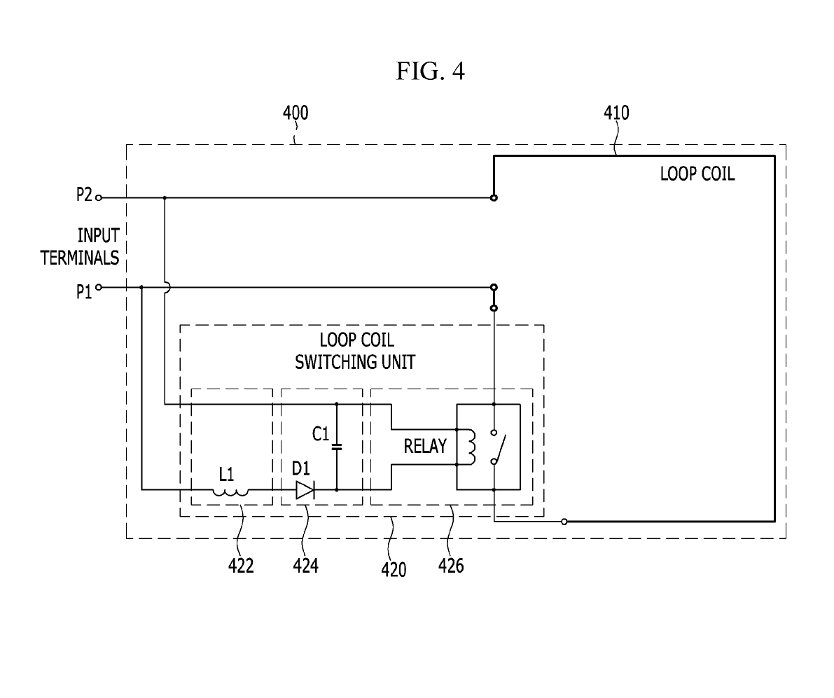

FIG. 4 is a view showing a detailed configuration of the loop coil switching unit of FIG. 2.

Referring to FIG. 4, the signal extractor 422 may include an inductor L1. The inductor L1 is connected between the input terminal P1 of the loop antenna 400 and the rectifier 424, and the magnitude of an RF signal applied to the rectifier 424 can be adjusted by adjusting the capacitance of the inductor L1.

The rectifier 424 includes a diode D1 and a capacitor C1, and an anode of the diode D1 is connected to the inductor L1 and a cathode of the diode D1 is connected to the switching unit 426.

The capacitor C1 is connected to the switching unit 426, and the capacitor C1 is also connected between the input terminals P1 and P22 of the loop antenna 400.

The capacitor C1 is connected between the cathode of the diode D1 and the switching unit 426, and the capacitor C1 is also connected to the input terminal P2 of the loop antenna 400. The diode D1 may be a Schottky diode. The rectifier 424 generates a DC voltage that is proportional to the magnitude of the received RF signal and outputs it to the switching unit 426.

The switch SW of the switching unit 426 may be a relay switch. The relay switch includes a coil and a switching terminal. The ends of the coil of the relay switch are connected between the cathode of the diode D1 and the input terminal P2 of the loop antenna 400, and the switching terminal of the relay switch is connected in series to the loop coil 410. If a DC voltage applied to the two ends of the coil of the relay switch is higher than the driving voltage of the relay switch, the relay switch is turned on to close the loop coil 410. If the DC voltage applied to the two ends of the coil of the relay switch is lower than the driving voltage of the relay switch, the relay switch is turned off to open the loop coil 410.

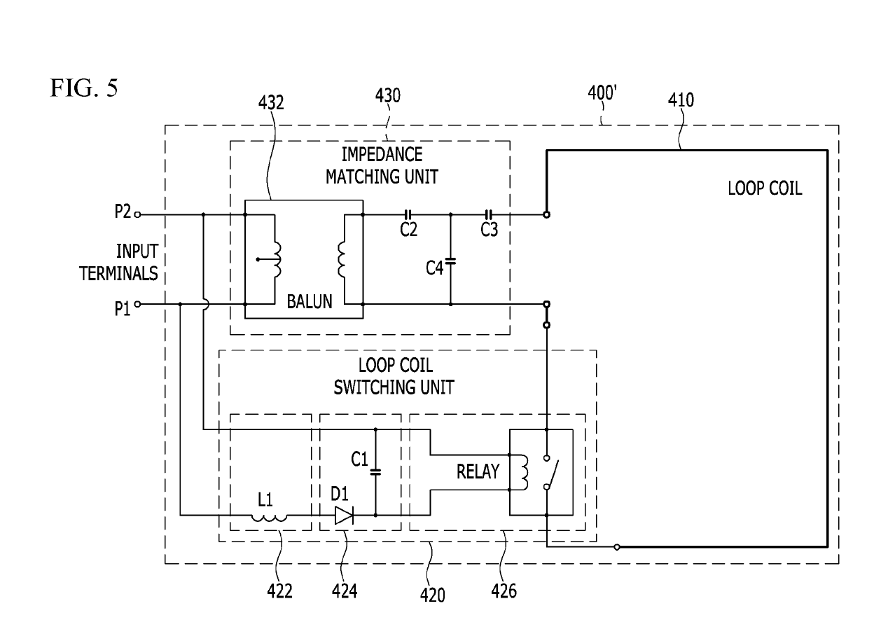

FIG. 5 is a view showing another example of a loop antenna according to an exemplary embodiment of the present invention.

Referring to FIG. 5, a loop antenna 400′ may further include an impedance matching unit 430. The impedance matching unit 430 matches the impedance between the feed cable 600 and the loop antenna 400′.

The impedance matching unit 430 may include a balun 432 and capacitors C2, C3, and C4. Impedance matching using the balun 432 is a well-known technology, so a detailed description thereof will be omitted.

According to an embodiment of the present invention, interference between neighboring loop antennas can be suppressed by opening and closing the switch for a coil constituting the loop antenna by a received RF signal, without supplying a switching control signal to each loop antenna.

An exemplary embodiment of the present invention may not only be embodied through the above-described apparatus and method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A loop antenna:
a loop coil connected to an RF signal source of a reader through a feed cable; and
a switch that is turned on and off depending on a DC voltage that is proportional to the magnitude of an RF signal supplied from the RF signal source of the reader, and opens the loop coil when turned off and closes the loop coil when turned on.

2. The loop antenna of claim 1, further comprising:
a signal extractor that extracts part of the RF signal; and
a rectifier that rectifies the extracted RF signal and converts the rectified RF signal into the DC voltage.

3. The loop antenna of claim 2, wherein the signal extractor comprises an inductor connected between a power line of the feed cable and the rectifier.

4. The loop antenna of claim 1, wherein the switch comprises a relay switch.

5. The loop antenna of claim 1, further comprising an impedance matching unit that matches the impedance between the feed cable and the loop antenna.

6. A method for switching a loop antenna, the method comprising:
generating a DC voltage that is proportional to the magnitude of an RF signal output from an RF signal source of a reader; and
closing or opening a loop coil constituting the loop antenna depending on the DC voltage.

7. The method of claim 6, wherein the loop antenna comprises a switch connected in the loop coil, and
the closing or opening comprises:
if the DC voltage is higher than a driving voltage of the switch, turning the switch on to close the loop coil; and
if the DC voltage is lower than the driving voltage of the switch, turning the switch off to open the loop coil.

8. The method of claim 7, wherein the switch comprises a relay switch.

9. The method of claim 6, wherein the generating comprises:
extracting part of the RF signal; and
rectifying the extracted RF signal and converting the rectified RF signal into the DC voltage.
